(19) United States
(12) Patent Application Publication
(10) Pub. No.: US 2008/0316983 A1
(43) Pub. Date: Dec. 25, 2008

(54) Service information in a LAN access point that regulates network service levels provided to communication terminals

(75) Inventor: Brian Daigle, Marietta, GA (US)

Correspondence Address: AT&T Legal Department;Attn: Patent Docketing, Room 2A-207, One AT&T Way, Bedminster, NJ, 07921, US

(73) Assignee: AT&T Intellectual Property, Inc.

(21) Appl. No.: 11/821,255

(22) Filed: Jun. 22, 2007

(51) Int. Cl. H04Q 7/24

(52) U.S. Cl. 370/338

(57) ABSTRACT

A LAN access point maintains service information that defines which of a plurality of network service levels is allocated to a plurality of communication terminals. The LAN point regulates the network service levels that it provides to the communication terminals in response to the service information. The service information may allocate different maximum communication bandwidth levels and/or allow/deny access to various network services to defined communication terminal identifiers, identifiers route locations hosted on communication terminals, and/or identifiers for users of the communication terminals. Moreover, the service information may define a time of day schedule and/or day of week schedule that varies the allocation of maximum communication bandwidth levels and/or access to various network services.

### FIELD OF THE INVENTION

This invention relates to communication networks and, more particularly, to controlling communications through a wireless local area network access point with communication terminals.

### BACKGROUND OF THE INVENTION

Wide area networks are used for intrastate, interstate, and worldwide communication of voice, video, and other data between networked communication devices. Such traffic is increasingly being carried as packets across packet networks, such as the Internet. To access such networks, a user obtains a fee-based subscription to a subscriber communication line to, for example, the user's premises from a network service provider. The subscriber line may be, for example, a Digital Subscriber Line (DSL) and/or a digital cable (e.g., digital television and/or data cable). The user may connect one or more communication devices through a local area network (LAN) access point, such as a wireless LAN access point, and a modem to the subscriber line. The LAN access point thereby interfaces the communication devices to the subscriber line and, therethrough, to the wide area communication network.

A network service provider may provide various fee-based services through the subscriber line to subscribers, which can include Internet access, Voice over Internet Protocol (VoIP) telephony, IP television (IP TV) (e.g., television content delivered via the Internet), and/or IP gaming (e.g., interactive gaming between various game consoles across the Internet). Such applications can have widely varying packet communication bandwidth characteristics and needs.

Some network service providers allocate different levels of bandwidth to subscriber lines based on tiered service plans, and constrain traffic through those subscriber lines to no more than the allocated bandwidths. While some bandwidth levels may be sufficient for some applications, such as Web browsing, they may be not be sufficient to provide an acceptable quality of service for real-time VoIP calls, IP TV, or IP gaming.

### SUMMARY OF THE INVENTION

In accordance with some embodiments of the present invention, a LAN access point maintains service information that defines which of a plurality of network service levels is allocated to a plurality of communication terminals. The LAN point regulates the network service levels that it provides to the communication terminals in response to the service information.

The service information may, for example, allocate different maximum communication bandwidth levels and/or allow/deny access to various network services to defined communication terminal identifiers, identifiers for applications hosted on communication terminals, and/or identifiers for users of the communication terminals. Moreover, the service information may define a time of day schedule and/or day of week schedule that varies the allocation of maximum communication bandwidth levels and/or access to various network services. Enabling differing network service levels to be provided through a LAN access point to different communication terminals, applications thereon and/or users thereof, may enable more efficient use of the LAN access point's bandwidth and/or may ensure that bandwidth is allocated to resources that need it the most. Moreover, regulating access to network services, such as VoIP services, IP TV services, or IP gaming services, for different communication terminals, applications thereon and/or users thereof, may enable yet more efficient use of the LAN access point's bandwidth and/or may allow more flexible control of the use of the services by defined users, communication terminals, and/or hosted applications.

Some other embodiments of the present invention are directed to a LAN access point that includes a repository of service information and an enforcement controller. The repository of service information defines which of a plurality of network service levels is allocated to a plurality of communication terminals. The enforcement controller is configured to regulate network service levels provided by the LAN access point to the communication terminals in response to the service information.

Some other embodiments of the present invention are directed to a network service provider that includes a subscriber account database and an access controller. The subscriber account database contains service information that defines which of a plurality of network service levels is allocated to communication terminals registered to a plurality of subscribers. The access controller is configured to communicate the service information.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 shows a block diagram of systems, methods, and/or computer program products in which a LAN access point regulates network service levels that it provides to a plurality of communication terminals in accordance with some embodiments of the present invention.

FIG. 2 shows a block diagram of the network service provider system and the LAN access point of FIG. 1 which are configured according to some embodiments of the present invention.

FIG. 3 shows a table that illustrates an exemplary repository of service information that defines which of a plurality of network service levels is allocated to the plurality of communication terminals, and which may reside in the LAN access point and/or in the network service provider system of FIG. 1 according to some embodiments of the present invention.

FIG. 4 shows a plurality of tables that illustrate another repository of service information that defines which of a plurality of network service levels is allocated to the plurality of communication terminals based on a time of day and day of week schedule, and which may reside in the LAN access point and/or in the network service provider of FIG. 1 according to some embodiments of the present invention.

FIG. 5 is a signal flowchart that illustrates systems, methods, and computer program products for defining the repository of service information within the LAN access point of FIG. 1 according to some embodiments of the present invention.

FIG. 6 is a signal flowchart that illustrates systems, methods, and computer program products for defining the repository of service information within the network service provider system and within the LAN access point of FIG. 1 according to some embodiments of the present invention.

FIG. 7 is a signal flowchart that illustrates systems, methods, and computer program products for regulating network services provided by the LAN access point to the communication terminals of FIG. 1 according to some embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element, it can be directly responsive to the other element, or intervening elements may be present. In contrast, when an element is referred to as being “directly responsive” to another elements, there are no intervening elements present. As used herein the term “and/or” includes any and all combinations of one or more of the associated listed items and may be abbreviated as “/”. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

It should also be noted that in some alternate implementations, the functions/acts noted in the blocks may occur out of the order noted in the block diagrams and/or flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

As will be explained below, some embodiments of the present invention may arise from a recognition of the need to provide different levels of network service in communications between a LAN access point and a plurality of communication terminals. In accordance with some embodiments, a LAN access point maintains service information that defines which of a plurality of network service levels is allocated to the communication terminals, and regulates the various network service levels that it provides to the communication terminals in response to that service information. The service information may, for example, allocate different maximum communication bandwidth levels and/or allow/deny access to various network services to defined communication terminal identifiers, identifiers for applications hosted on communication terminals, and/or identifiers for users of the communication terminals. Moreover, the service information may define a time of day schedule and/or day of week schedule that varies the allocation of maximum communication bandwidth levels and/or access to various network services. Enabling differing network service levels to be provided through a LAN access point to different communication terminals, or applications thereon and/or users thereof, may enable more efficient use of the LAN access point's bandwidth and/or may ensure that bandwidth is allocated to resources that need it the most.

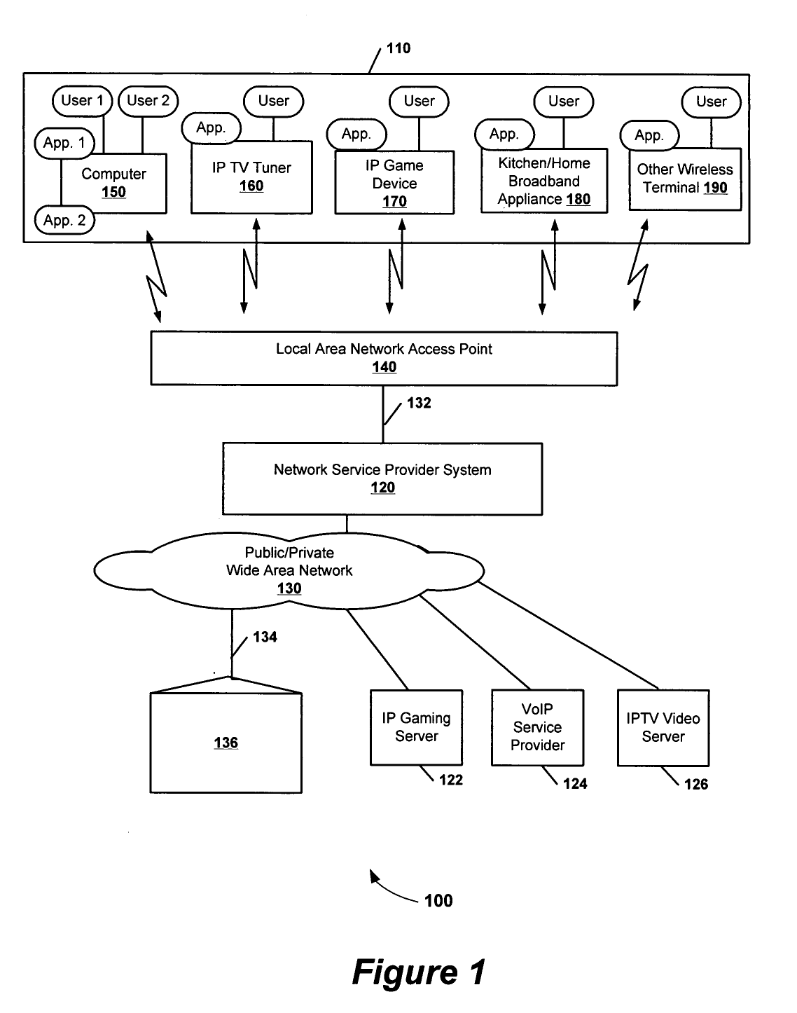

FIG. 1 is a block diagram of a communication system 100 and related methods and/or computer program products configured in accordance with some embodiments of the present invention. The communication system 100 can include a network service provider system (“service provider”) 120 and a public/private wide area network 130. Users may subscribe to fee-based services provided by the service provider 120 to access the wide area network 130, such as from the users' premises (e.g., home, office, etc.). For example, subscriber equipment 110 is networked to the wide area network 130 through a subscriber line 132 which is operated by the service provider 120. Similarly, other subscriber equipment 136 may be networked to the wide area network 130 through another subscriber line 134 which is operated by the service provider 120. The wide area network 130 may include public/private networks, such as the Internet and/or other packet switched networks and may include a combination of one or more wired and/or wireless packet switched networks (e.g., cellular, WiMAX, etc.).

The subscriber equipment 110 may include a plurality of end user communication terminals, such as, for example, web browser and/or other applications hosted on a computer 150, an IP TV tuner 160, an IP gaming device 170, a kitchen/home broadband appliance 180, and other wireless terminals 190, each of which may be connected through a LAN access point 140 to the subscriber line 132. One or more of the communication terminals 150-190 may host one or more applications “App.”, such as software applications configured to carry out various defined functionality thereon, and may be operated by one or more users.

The computer 150 may include, but is not limited to, a laptop, desktop, palmtop, and/or personal digital assistant (PDA) based computer that may host a Web browser application and/or other application programs. The IP TV tuner 160 may include, but is not limited to, a cable tuner, satellite tuner, and/or an IP browser. The IP TV 160 may be configured as an interactive on-demand TV through which a user can select among a plurality of TV programs hosted on a IP TV video server 126, which may reside in the service provider 120 or across the wide area network 130, for display on the IP TV 160. The IP gaming device 170 may be configured as a software module hosted on a general purpose computer and/or as a specialized gaming console that shares data and/or program instructions with other IP gaming devices and/or with a gaming server 122 via the service provider 120 and the wide area network 130. The other wireless terminals 190 may include, but are not limited to, a voice over Internet protocol VoIP phone which may be configured to convert voice into digital packets which are communicated through a VoIP service provider 124, which may reside in the service provider 120 or across the wide area network 130, to another VoIP phone and/or to a plain old telephone system (POTS) phone. The broadband appliance 180 may be, for example, a refrigerator, dishwasher, and/or temperature thermostat which may be configured to be controllable via communications through the LAN access point 140 and the wide area network 130.

The LAN access point 140 may be a wireless LAN router that is configured to communicate across an air interface with the subscriber equipment 110 using one or more wireless communication protocols, which may include, but are not limited to, IEEE 802.11b-g based protocols. The LAN access point 140 may additionally or alternatively be configured to interconnect to the communication terminals 150-190 by wired network connections (e.g., Ethernet). The LAN access point 140 aggregates signals from the communication terminals 150-190 and communicates packetized data through a digital modem, such as a DSL modem and/or a digital cable modem, and the subscriber line 132. The digital modem may be at least partially within the LAN access point 140 or may be separate therefrom (e.g., connected between the LAN access point 140 and the subscriber line 132).

The computer 150, IP TV tuner 160, the IP gaming device 170, the broadband appliance 180, and the other wireless terminals 190 can have significantly different packet data communication bandwidth characteristics and needs. For example, the IP gaming device 170 and the IP TV tuner 160 may transmit/receive real-time high-bandwidth packetized video streams through the subscriber line 132. In contrast, the broadband appliance 180 and/or some types of the other wireless terminals 190 may transmit/receive lower-bandwidth real-time packetized voice streams through the subscriber line 132. A Web browser application hosted on the computer 150 may transmit/receive yet lower-bandwidth non-real-time packetized data through the subscriber line 132.

The LAN access point 140 may regulate differing levels (e.g., quantized tiers and/or a continuum of levels within a range) of network services for different ones of the communication terminals 150-190. For example, the LAN access point 140 can regulate different levels of maximum communication bandwidth, prioritization of communication bandwidth for one communication terminal over another, and/or different network services including, but not limited to, VoIP telephony services, IPTV services, Internet access, and/or IP gaming services to one or more of the communication terminals 150-190. Such regulation of network service levels may be provided by the LAN access point 140 maintain service information that defines which network service level is allocated to which of the communication terminals 150-190, and to regulate the various network service levels that it provides to the communication terminals 150-190 in response to that service information.

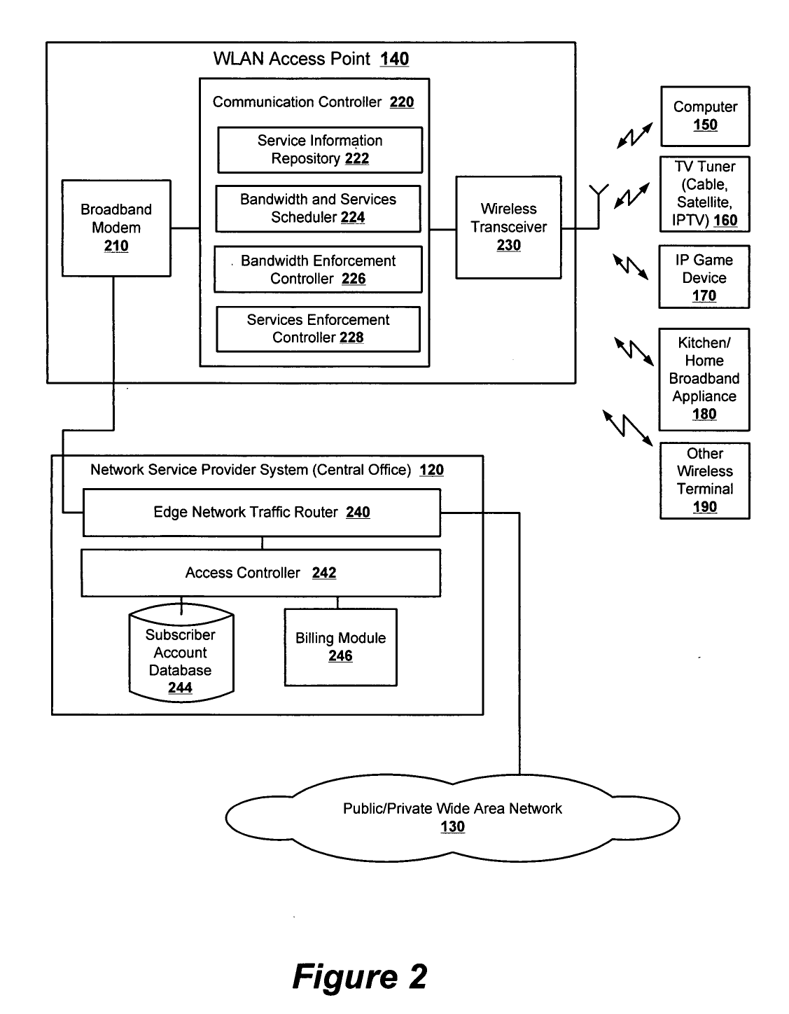

FIG. 2 shows in further detail a block diagram of the LAN access point 140 and the service provider 120 of FIG. 1 in accordance with some embodiments of the present invention. Referring to FIG. 2, the LAN access point 140 may be, for example, a digital subscriber line (DSL)/digital cable wireless LAN (WLAN) access point (e.g., WLAN router).

The WLAN access point 140 may include a broadband modem 210, a communication controller 220, and a wireless transceiver 230. The broadband modem 200 is configured to bidirectionally communicate with the wide area network 130 through the service provider 120. The wireless transceiver 230 is configured to communicate across an air interface with the communication terminals 150-190 according to one or more wireless LAN protocols, which may include, but are not limited to, IEEE 802.11a-g. The communication controller 220 is configured to maintaining service information that defines which network service level is allocated to which of the communication terminals 150-190, and regulating the various network service levels that it provides to the communication terminals 150-190 in response to that service information.

The communication controller 220 may include a services information repository 222 (e.g., information table, database, or other listing of information associations), a bandwidth and services scheduler 224, a bandwidth enforcement controller 226, and a services enforcement controller 228. Although the controllers 222, 224, 226, and 228 have been illustrated as separate blocks for ease of explanation, is to be understood that their functionality may be combined within a single data processing element (e.g., a microprocessor executing software code) or distributed across a plurality of data processing elements.

The service provider 120 may include an edge network traffic router 240, an access controller 242, a subscriber account database. 244, and a billing module 246. The edge network traffic router 240 is configured to interface the LAN access point 140 to the wide area network 130. The edge network traffic router 240 may include a DSL Access Multiplexer (DSLAM) device and/or a digital cable line access module that may reside as part of a digital loop carrier that aggregates signals from one or more LAN access points on a high-speed communications backbone line of the wide area network 130.

The LAN access point 140 stores service information in the repository that defines which of a plurality of network service levels is allocated to the communication terminals 150-190. For example, the service information may allocate different levels of maximum communication bandwidth, prioritization of communication bandwidth for one communication terminal over another, and/or allow/deny access to various network services including, but not limited to, VoIP telephony services, IPTV services, Internet access, and/or IP gaming services to one or more of the identifiers for the communication terminals 150-190, identifiers for applications hosted on the communication terminals 150-190, and/or identifiers of users of the communication terminals 150-190. Moreover, the service information may define a time of day schedule and/or day of week schedule that varies the allocation of maximum communication bandwidth levels and/or access to various network services.

The bandwidth and services scheduler 224 may include a clock circuit and a calendar function which is configured to change the network service levels allocated to the communication terminals 150-190, hosted applications, and/or users according to the time of day schedule and/or day of week schedule defined in the service information of the repository 222. The bandwidth enforcement controller 226 is configured to constrain communications between the LAN access point 140 and the communication terminals 150-190, the hosted applications, and/or the users based on the maximum communication bandwidth defined by the network service levels in the repository 222. The services enforcement controller 228 is configured to selectively authorize/deny access to one or more network services which may include, but not limited to, VoIP telephony services, IP TV services, Internet access, and/or IP gaming services, to the communication terminals 150-190, the hosted applications, and/or the users based on the network service levels in the repository 222.

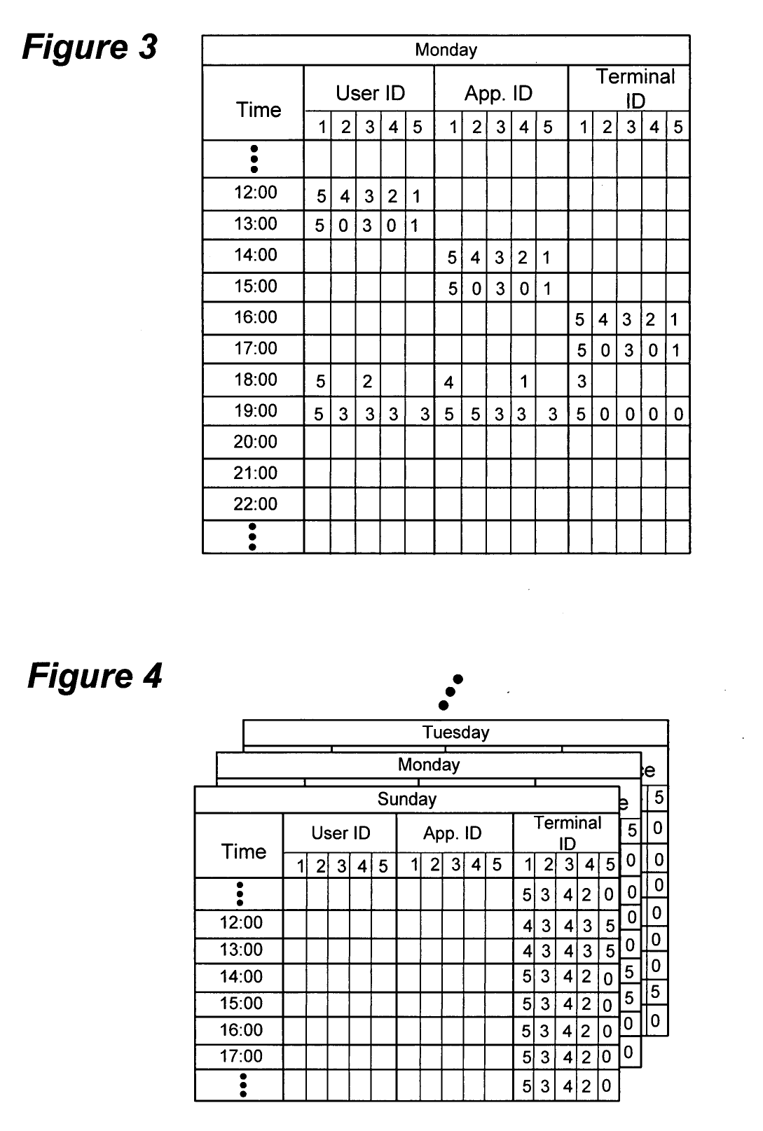

FIG. 3 shows a table that illustrates exemplary service information that may be stored in the repository 222 and used by communication controller 220 to regulate the network service levels provided to the communication terminals 150-190. As will be further described below, the service information may also be stored in the subscriber account database 244 of the service provider 120. Referring to FIG. 3, the service information associates six different tiers of network services (e.g., 0-5) to identifiers for communication terminals, identifiers for applications which are hosted on the communication terminals, and identifiers for users who may use the communication terminals to access the WLAN access point 140.

Each of the terminal identifiers may correspond to a MAC address (media access control address) associated with a LAN transceiver, such as a wireless LAN transceiver, in each of the communication terminals 150-190. The MAC address is a unique identifier that may be assigned to LAN interface circuits and used during network communications to identify the communicating terminal.

Each of the user identifiers may correspond to a user name or other user attribute which may be received by the LAN access point 140 in response to the user carrying out a log-in procedure in which the user identifier is entered by a user. Alternatively or additionally, the user identifier may correspond to a unique identifier that resides in the communication terminal (e.g., as a cookie) and is communicated to the LAN access point 140 when a user is operating the communication terminal.

The application identifier may correspond to an application serial number or other unique identifier that is communicated by an application from a communication terminal to the LAN access point 140. The application identifier may alternatively or additionally correspond to defined communication characteristics of an application, including, but not limited to, a protocol that is indicative of communications from a particular application. The LAN access point 140 may analyze data and/or control information received from a communication terminal to identify a voice encoding algorithm, video encoding algorithm, and/or control protocol (e.g., user datagram protocol, real-time protocol, TCP, and/or HTTP) that is indicative of communications originating from a particular type of application (e.g., VoIP telephony application, IPTV application, Internet browsing application, and/or IP gaming application) hosted on a communication terminal.

The six different levels of network services may include a lowest level (“0”) that allocates zero bandwidth and denies access to the VoIP, IPTV, and IP gaming services, thereby blocking access through the WLAN access point 140. Five sequentially higher network service levels (“1”-“5”) may allocate increasing greater levels of maximum communication bandwidth and/or access to more of the VoIP, IPTV, and IP gaming services. For example, when a user identifier, application identifier, or terminal identifier is allocated a network service level of 5, it may obtain the highest maximum communication bandwidth available through the LAN access point 140 and may be granted access to all network services, such as VoIP services, IP TV services, and IP gaming services. In contrast, when a user identifier, application identifier, or terminal identifier is allocated a network service level of 1, it may obtain the lowest operational level of maximum communication bandwidth, or lowest priority level of communication bandwidth relative to higher network service levels, through the LAN access point 140 and may be granted access to a single type of network services, such as one of the VoIP services, IP TV services, and IP gaming services.

With continuing reference to FIG. 3, the service information may also define a time of day schedule over which the network service levels assigned to the user IDs, application identifiers, and/or terminal IDs varies. By way of further example, the subscriber information defines that, at 12:00, user identifiers 1, 2, 3, 4, and 5 are allocated network service levels 5, 4, 3, 2, and 1, respectively. Subsequently, at 13:00, user identifiers 2 and 4 are both allocated a 0 network service level, which, in some embodiments, effectively blocks those users from obtaining network services. Subsequently, at 14:00, application identifiers 1, 2, 3, 4, and 5, are allocated network service levels 5, 4, 3, 2, and 1, respectively. At 15:00, application identifiers 2 and 4 are both allocated a 0 network service level, which, in some embodiments, effectively blocks those applications from obtaining network services. At 16:00, terminal identifiers 1, 2, 3, 4, and 5, are allocated network service levels 5, 4, 3, 2, and 1, respectively. At 17:00, terminal identifiers 2 and 4 are both allocated a 0 network service level, which, in some embodiments, effectively blocks those communication terminals from obtaining network services. At 18:00, the service information allocates various network service levels to a combination of user identifiers, application identifiers, and terminal identifiers, and at 19:00, the service information allocates various network service levels to all of the listed user identifiers, application identifiers and terminal identifiers.

The service information may further define a day of week schedule over which the network service levels assigned to the user IDs, application identifiers, and/or terminal IDs varies. FIG. 4 shows a plurality of tables that illustrates which of a plurality of network service levels is allocated to the user identifiers, application identifiers, and terminal identifiers based on a time of day and day of week schedule, and which may reside in the service information repository 222 in the LAN access point 140. With reference to FIG. 4, the communication terminal having identifier 5 is allocated network service level 0 at all times on Sunday except between 12:00-14:00. Such network service allocation to terminal identifier 5 may correspond to, for example, limiting an Internet gaming console (e.g., XBOX /PLAYSTATION) to being used on Sunday only between the hours of 12:00-14:00. On Monday, terminal identifier 5 is allocated network service level 0 at all times except between 15:00-17:00, and on Tuesday, terminal identifier five is allocated network service-level) at all times except between 16:00-17:00. Accordingly, an IP gaming console may thereby be further constrained to being used on Monday only between the hours of 15:00-17:00, and on Tuesday only between the hours of 16:00-17:00.

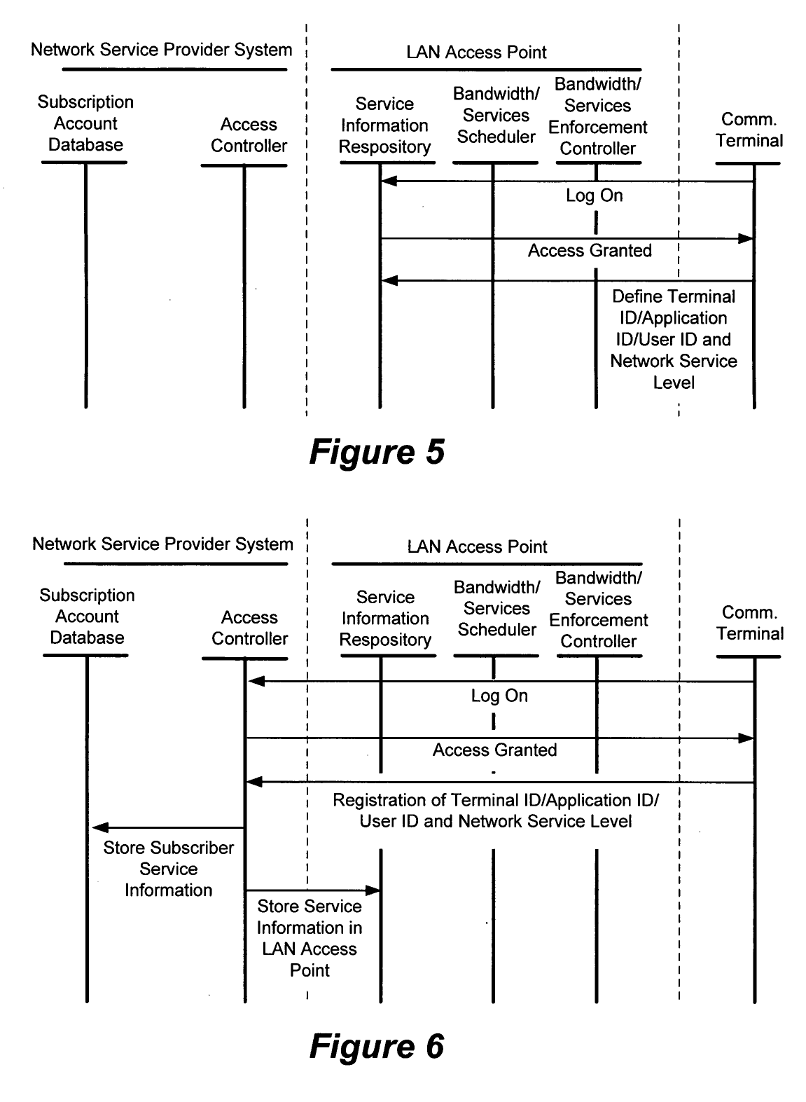

The service information in the repository 222 may be defined by a user through one or more of the communication terminals 150-190. FIG. 5 is a signal flowchart that illustrates systems, methods, and computer program products that can allow a user to define service information in the repository 222. Referring to FIG. 5, a user may log-on the LAN access point 140. Upon being granted access, the user may then edit a table, such as that shown in FIG. 3 and/or FIG. 4, or otherwise define/change associations for service information in the repository 222 to assign network service levels to user identifiers, application identifiers, and/or terminal identifiers and which may further defined so as to change based on a time of day schedule and/or a day of week schedule. Accordingly, the user may regulate the utilization of the limited bandwidth/services available through the LAN access point 140 to prioritize providing bandwidth to certain defined terminal identifiers, user identifiers, and/or application identifiers. Thus, for example, a parent may prioritize a computer that is used for work purposes to have a higher network service level than an IP gaming console operated by children, the IP TV 160, and/or the kitchen appliance 180. Moreover, the user may define such prioritization to occur only during normal business hours and during a Monday-Friday workweek, and may provide a higher network service level to the IP TV 160 in the evenings and on the weekends.

Alternatively or additionally, the user may define service information in the subscriber account database 244 of the service provider 120, and that service information can then be communicated from the service provider 120 to the repository 222 in the LAN access point 140. FIG. 6 is a signal flowchart that illustrates systems, methods, and computer program products that can allow a user to define service information in the subscriber account database 224 and subsequent transfer to the repository 222. Referring to FIG. 6, the user logs-on the access controller 242 of the service provider 120 through the LAN access point 140, or may log-on through another LAN access point or by other means. Upon being granted access, a user may then edit, via the access controller 242, a table, such as that shown in FIG. 3 and/or FIG. 4, or other associations defined by the service information in the subscriber account database to 244 to assign network service levels to user identifiers, application identifiers, and/or terminal identifiers, and may further define those associations to change based on a time of day schedule and/or a day of week schedule. The access controller 242 may then communicate some or all of the subscriber information to the repository 222 of the LAN access point 140. The billing module 246 in the service provider 120 may charge fees to subscribers for such service-level allocations and associated regulation thereof Accordingly, the user may define the subscriber information in the database to 44 of the service provider 120, and have that information then replicated out to one or more LAN access points are utilized by the user to obtain network services.

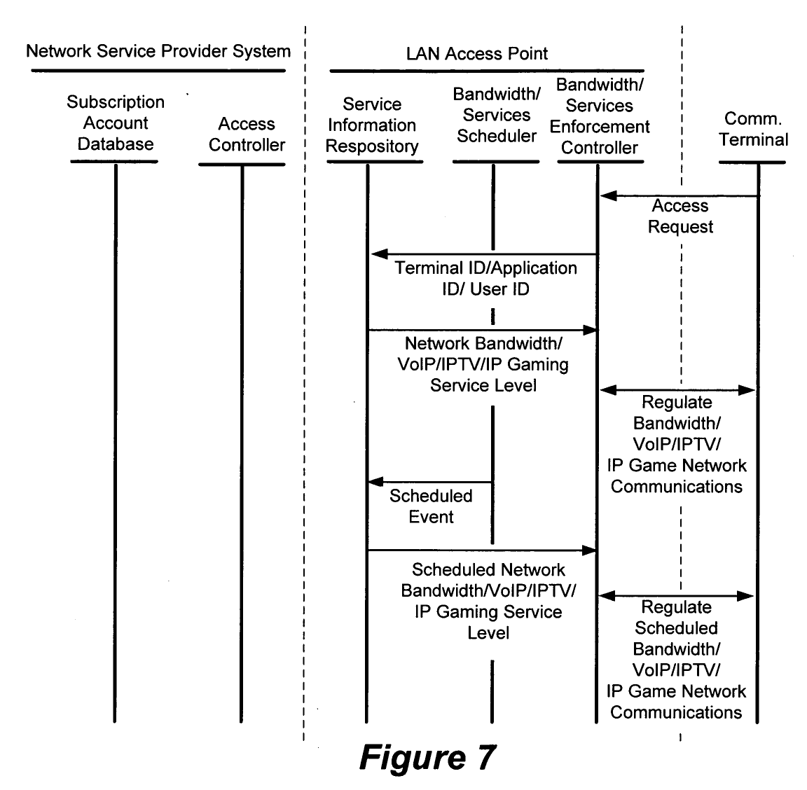

FIG. 7 is a signal flowchart that illustrates systems, methods, and computer program products for regulating network services provided by the LAN access point 140 to the communication terminals 150-190 of FIG. 1 according to some embodiments. The communication terminal communicates a network access request that may include an identifier for the communication terminal, such as a MAC address thereof, a user identifier (e.g., user login ID), and/or an application identifier to the bandwidth enforcement controller 226 and to the services enforcement controller 228. The bandwidth enforcement controller 226 and/or the services enforcement controller 228 query the repository 222 using the received terminal identifier, application identifier, and/or user identifier to obtain services information allocated thereto, which may define a maximum communication bandwidth and/or identify network services that may be allowed or denied. The bandwidth enforcement controller 226 constrains communications between the LAN access point 140 in the communication terminal to no more than the maximum communication bandwidth defined by the service information in the repository 222. The services enforcement controller 228 selectively grants/denies access to one or more network services defined by the service information to the communication terminal.

As described above, the bandwidth and services scheduler 224 may include a clock and/or calendar circuitry which, upon a scheduled event, can change the network service level allocated to the communication terminal in response to the defined time of day and/or day of week schedule in the service information of the repository 222. Accordingly, in response to a scheduled event, the bandwidth services scheduler 224 may provide a different maximum communications bandwidth to the bandwidth enforcement controller 220 for constraining communication bandwidth between the LAN access point 140 and the communication terminal, and/or may provide a different list of granted/denied network services which may be used by the communication terminal.

Accordingly, a LAN access point can maintain service information that defines which of a plurality of network service levels is allocated to communication terminals, hosted applications, and users, and regulates the various network service levels that it provides thereto in response to that service information. The service information may, for example, allocate different maximum communication bandwidth levels and/or allow/deny access to various network services to defined communication terminal identifiers, identifiers for applications hosted on communication terminals, and/or identifiers for users of the communication terminals. Moreover, the service information may define a time of day schedule and/or day of week schedule that varies the allocation of maximum communication bandwidth levels and/or access to various network services. Enabling differing network service levels to be provided through a LAN access point to different communication terminals, or applications thereon and/or users thereof, may enable more efficient use of the LAN access point's bandwidth and/or may ensure that bandwidth is allocated to resources that need it the most.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of regulating network services provided by a local area network (LAN) access point to a plurality of communication terminals, the method comprising:
maintaining service information at a LAN access point that defines which of a plurality of network service levels is allocated to the communication terminals; and
regulating network service levels provided by the LAN access point to the communication terminals in response to the service information.

2. The method of claim 1, wherein:
the service information further defines a time of day schedule over which at least some of the plurality of network service levels allocated to the communication terminals changes; and
the network service levels provided by the LAN access point to the communication terminals are regulated according to the defined time of day schedule in the service information.

3. The method of claim 2, wherein:
the service information further defines a day of week schedule over which at least some of the plurality of network service levels allocated to the communication terminals changes; and
the network service levels provided by the LAN access point to the communication terminals are regulated according to the defined day of week schedule in the service information.

4. The method of claim 1, wherein:
maintaining service information comprises associating terminal identifiers, for the communication terminals, with assigned ones of the plurality of network service levels; and
regulating network service levels comprises receiving a terminal identifier from a communication terminal, using the received terminal identifier to look-up in the service information an assigned network service level for the communication terminal, and regulating communications between the LAN access point and the communication terminal in response to the assigned network service level.

5. The method of claim 4, wherein:
maintaining service information comprises associating MAC addresses of the communication terminals with assigned ones of the plurality of network service levels; and
regulating network service levels further comprises:
receiving a MAC address from a communication terminal;
using the received MAC address to look-up in the service information an assigned network service level for the communication terminal; and
regulating communications between the LAN access point in the communication terminal in response to the assigned network service level.

6. The method of claim 4, wherein:
the service information allocates a first level of maximum communication bandwidth to a first terminal identifier and a second level of maximum communication bandwidth, which is different from the first level, to a second terminal identifier; and
the LAN access point constrains communications with a first communication terminal having the first terminal identifier based on the first level of maximum communication bandwidth and constrains communications with a second communication terminal having the second terminal identifier based on the second level of maximum communication bandwidth.

7. The method of claim 1, wherein:
maintaining service information comprises associating application identifiers, for applications hosted on the communication terminals, with assigned ones of the plurality of network service levels; and
regulating network service levels comprises:
receiving an application identifier from an application hosted on a communication terminal;
using the received application identifier to look-up in the service information an assigned network service level for the application; and
regulating communications between the LAN access point and the communication terminal hosting the application in response to the assigned network service level.

8. The method of claim 7, wherein:
the service information allocates a first level of maximum communication bandwidth to a first application identifier and a second level of maximum communication bandwidth, which is different from the first level, to a second application identifier; and
the LAN access point constrains communications with a first application, hosted on a communication terminal, having the first application identifier based on the first level of maximum communication bandwidth, and constrains communications with a second application, hosted on the communication terminal, having the second application identifier based on the second level of maximum communication bandwidth.

9. The method of claim 1, wherein:
maintaining service information comprises associating user identifiers, for users registered to use the communication terminals, with assigned ones of the plurality of network service levels; and
regulating network service levels comprises:
receiving a user identifier from a communication terminal;
using the received user identifier to look-up in the service information an assigned network service level for the user; and
regulating communications between the LAN access point and the communication terminal in response to the assigned network service level.

10. The method of claim 9, wherein:
the service information allocates a first level of maximum communication bandwidth to a first user identifier and a second level of maximum communication bandwidth, which is different from the first level, to a second user identifier; and
the LAN access point constrains communications with a first user, of a communication terminal, having the first user identifier based on the first level of maximum communication bandwidth, and constrains communications with a second user, of the communication terminal, having the second user identifier based on the second level of maximum communication bandwidth.

11. The method of claim 1, wherein:
regulating network service levels comprises regulating communications by the LAN access point with first and second communication terminals to prioritize allocation of communication bandwidth to the first communication terminal over allocation of communication bandwidth to the second communication terminal in response to the service information.

12. The method of claim 1, wherein:
the LAN access point comprises a wireless LAN router that allocates wireless communication bandwidth to the communication terminals in response to the service information, and constrains communications with the communication terminals in response to the allocated wireless communication bandwidth.

13. The method of claim 1, wherein:
the service information does not authorize Voice Over Internet Protocol (VoIP) service for a first communication terminal and authorizes VoIP service for a second communication terminal; and
the LAN access point is regulated in response to the service information to allow VoIP service to the second communication terminal and to deny VoIP service to the first communication terminal.

14. The method of claim 1, wherein:
the service information does not authorize Internet Protocol Television (IP TV) service for a first communication terminal and authorizes IP TV service for a second communication terminal; and
the LAN access point is regulated in response to the service information to allow IP TV service to the second communication terminal and to deny IP TV service to the first communication terminal.

15. The method of claim 1, wherein:
the service information does not authorize IP gaming service for a first communication terminal and authorizes IP gaming service for a second communication terminal; and
the LAN access point is regulated in response to the service information to allow IP gaming service to the second communication terminal and to deny IP gaming service to the first communication terminal.

16. A local area network (LAN) access point comprising:
a repository of service information that defines which of a plurality of network service levels is allocated to the plurality of communication terminals; and
an enforcement controller that is configured to regulate network service levels provided by the LAN access point to the communication terminals in response to the service information.

17. The LAN access point of claim 16, wherein:
the service information in the repository defines which of a plurality of maximum communication bandwidth levels is allocated to each of the plurality of communication terminals; and
the enforcement controller comprises a bandwidth enforcement controller that is configured to constrain communications between the LAN access point and the communication terminals in response to the maximum communication bandwidth levels allocated to the respective communication terminals.

18. The LAN access point of claim 16, wherein the service information in the repository further defines a time of day schedule over which at least some of the plurality of network service levels allocated to the communication terminals changes, and further comprising a scheduler that is configured to regulate the network service levels provided by the LAN access point to the communication terminals according to the defined time of day schedule in the service information.

19. The LAN access point of claim 18, wherein the service information in the repository further defines a day of week schedule over which at least some of the plurality of network service levels allocated to the communication terminals changes, and further comprising a scheduler that is configured to regulate the network service levels provided by the LAN access point to the communication terminals according to the defined day of week schedule in the service information.

20. The LAN access point of claim 16, wherein:
the service information in the repository associates terminal identifiers for the communication terminals with assigned ones of the plurality of network service levels; and
the enforcement controller is further configured to use a terminal identifier received from a communication terminal to look-up in the service information an assigned network service level for the communication terminal, and to regulate communications between the LAN access point and the communication terminal in response to the assigned network service level.

21. The LAN access point of claim 20, wherein:
the service information in the repository associates MAC addresses of the communication terminals with assigned ones of the plurality of network service levels; and
the enforcement controller is further configured to use a MAC address received from a communication terminal to look-up in the service information an assigned network service level for the communication terminal, and to regulate communications between the LAN access point and the communication terminal in response to the assigned network service level.

22. The LAN access point of claim 21, wherein:
the service information in the repository allocates a first level of maximum communication bandwidth to a first terminal identifier and a second level of maximum communication bandwidth, which is different from the first level, to a second terminal identifier; and
the enforcement controller comprises a bandwidth enforcement controller that is configured to constrain communications with a first communication terminal having the first terminal identifier based on the first level of maximum communication bandwidth and to constrain communications with a second communication terminal having the second terminal identifier based on the second level of maximum communication bandwidth.

23. The LAN access point of claim 16, wherein:
the service information in the repository associates application identifiers, for applications hosted on the communication terminals, with assigned ones of the plurality of network service levels; and
the enforcement controller comprises a bandwidth enforcement controller that is configured to use an application identifier received from an application hosted on a communication terminal to look-up in the service information of the repository an assigned network service level for the application, and to regulate communications between the LAN access point and the communication terminal hosting the application in response to the assigned network service level.

24. The LAN access point of claim 23, wherein:
the service information in the repository allocates a first level of maximum communication bandwidth to a first application identifier and a second level of maximum communication bandwidth, which is different from the first level, to a second application identifier; and
the bandwidth enforcement controller is further configured to constrain communications with a first application, hosted on a communication terminal, having the first application identifier based on the first level of maximum communication bandwidth, and to constrain communications with a second application, hosted on the communication terminal, having the second application identifier based on the second level of maximum communication bandwidth.

25. The LAN access point of claim 16, wherein:
the service information in the repository associates user identifiers, for users registered to use the communication terminals, with assigned ones of the plurality of network service levels; and
the enforcement controller comprises a bandwidth enforcement controller that is configured to use a user identifier received from a communication terminal to look-up in the service information of the repository an assigned network service level for the user, and to regulate communications between the LAN access point and the communication terminal in response to the assigned network service level.

26. The LAN access point of claim 25, wherein:
the service information in the repository allocates a first level of maximum communication bandwidth to a first user identifier and a second level of maximum communication bandwidth, which is different from the first level, to a second user identifier; and
the bandwidth enforcement controller is further configured to constrain communications with a first user, of a communication terminal, having the first user identifier based on the first level of maximum communication bandwidth, and to constrain communications with a second user, of the communication terminal, having the second user identifier based on the second level of maximum communication bandwidth.

27. The LAN access point of claim 16, further comprising:
a broadband modem that is configured to communicate through a subscriber line and a network service provider system; and
a wireless transceiver that is configured to communicate through a wireless air interface with the plurality of communication terminals according to one or more wireless local area network protocols, wherein the enforcement controller comprises a bandwidth enforcement controller that is configured to constrain bandwidth of communications through the wireless air interface with each of the plurality of communication terminals according to the service information in the repository for the respective communication terminals.

28. The LAN access point of claim 16, wherein:
the service information in the repository does not authorize Voice Over Internet Protocol (VoIP) service for a first communication terminal and authorizes VoIP service for a second communication terminal; and
the enforcement controller comprises a services enforcement controller that is configured to allow VoIP service to the second communication terminal and to deny VoIP service to the first communication terminal.

29. The LAN access point of claim 16, wherein:
the service information in the repository does not authorize Internet Protocol Television (IP TV) service for a first communication terminal and authorizes IP TV service for a second communication terminal; and
the enforcement controller comprises a services enforcement controller that is configured to allow IP TV service to the second communication terminal and to deny IP TV service to the first communication terminal.

30. The LAN access point of claim 16, wherein:
the service information in the repository does not authorize IP gaming service for a first communication terminal and authorizes IP gaming service for a second communication terminal; and
the enforcement controller comprises a services enforcement controller that is configured to allow IP gaming service to the second communication terminal and to deny IP gaming service to the first communication terminal.

31. A network service provider comprising:
a subscriber account database that contains service information that defines which of a plurality of network service levels is allocated to communication terminals registered to a plurality of subscribers; and
an access controller is configured to communicate the service information, defining which of a plurality of network service levels is allocated to a plurality of identified communication terminals, to a local area network access point.
